(19) United States
(12) Patent Application Publication
(10) Pub. No.: US 2011/0133893 A1
(43) Pub. Date: Jun. 9, 2011

(54) Recycle bag identification tag

(76) Inventor: Vivian Elena Evora Only A Chief, Norwalk, CA (US)

(21) Appl. No.: 12/928,099

(22) Filed: Dec. 3, 2010

Related U.S. Application Data
(60) Provisional application No. 61/283,443, filed on Dec. 3, 2009.

(51) Int. Cl. G06K 7/01; G06K 19/077; G06K 19/06; G06F 17/00; B42D 15/00

(52) U.S. Cl. 340/10.1; 235/492; 235/494; 235/375; 283/74; 283/67

(57) ABSTRACT

A recycle identification (ID) tag and method for organizing and labeling a recycle ID tag connected by an attachment mechanism to an aperture in a flat body at a first end, and the attachment mechanism connected to a recycle bag at a second end. A first identifying inscription of an association to a specific user is provided on a space for inscribing an identification inscription on a first side of the ID tag. An image is provided on a second side of the ID tag. The first identifying inscription may be at least one of a chronological numbering or alphabetizing adapted to identify to the user of the quantity of recycle bags in, or missing from, her possession.

### CROSS REFERENCE TO RELATED APPLICATION

This application is a Non-Provisional Application which claims the benefit of the filing date of U.S. Provisional Application Ser. No. 61/283,443, entitled “Recycle Bag ID Tag” filed Dec. 3, 2009, which incorporates by reference all of the subject matter therein.

### BACKGROUND

1. Field

This subject disclosure relates generally to a recycle bag identification (ID) tag and, more particularly, to a recycle bag ID tag provided for organization and identification for various recycle bags.

2. Description of the Related Art

Environmentalism is a broad philosophy and social movement centered on a concern for the conservation and improvement of the natural environment, both for its own sake as well as its importance to civilization. Environmentalists frequently speak of a planet or place faced with a plethora of grave and urgent threats; often associated with unbridled consumption, economic growth, materialism, insensitive development, and booming human numbers. In practice, however, most environmentalists tend to fall in on the reformist end of the spectrum, with countless campaigns to reform laws, elect sympathetic lawmakers and win over the public. In fact, one success of the reformist movement is a Los Angeles law, i.e., outlawing the use of plastic bags in supermarkets and fast food restaurants.

Free-market environmentalists believe that environmental stewardship begins with a respect for private property, and that the natural tendency is to reject contamination of one's environment by expulsion of aggressors. Nonetheless, the drive of many reform environmentalists probably lies in heartfelt views quite sympathetic to those of the radicals, albeit more inclined to a kind of pragmatism. Regardless of level of environmental passion, it is readily apparent that the focus of environmentalism in the 21st Century is “going green”.

Clearly there is an environmental push to respect and conserve the environment. Various communities have already imposed ordinances that ban stores from using single-use plastic bags in hopes of encouraging recycling and preventing billions of plastic bags from polluting neighborhoods and waterways. In the alternative, other green communities are imposing a 10 cent charge per paper bag in an attempt to encourage shoppers to purchase and tote around their own recyclable bags. This green movement requiring all shoppers to purchase, bring in and shop with their own bags yields a new unprecedented concern for their various recycle bags. With so many shoppers carrying similar bags, now, the average consumer will have to care for, and be able to distinguish all of their own recycle bags from other patrons carrying identical appearing bags. As such, this subject disclosure proposes a solution to maintaining the organization and identity of a particular users' recycle bags as will be described in more detail below.

### SUMMARY

The following presents a simplified summary of the subject disclosure in order to provide a basic understanding of some aspects thereof. This summary is not an extensive overview of the various embodiments of the subject disclosure. It is intended to neither identify key or critical elements of the subject disclosure nor delineate any scope thereof. The sole purpose of the subject summary is to present some concepts in a simplified form as a prelude to the more detailed description that is presented hereinafter.

A recycle ID tag for a recycle bag is disclosed. The recycle ID tag has a substantially flat body and an attachment mechanism. The substantially flat body is constructed in a preferred shape and has a first side having a space for inscribing an identification inscription. A second side includes an image. The attachment mechanism is connected to an aperture in the flat body at a first end, and connected to the recycle bag at a second end.

The recycle ID tag is adapted to communicate with a management system in a retail establishment. The management system includes a central processor connected to a database containing information pertinent to the recycle ID tag. A transmit/receiver may also be located at an entrance, exit or throughout the establishment. The transmit/receiver communicates data information from a communication element in the recycle ID tag and to and from the central processor.

In another embodiment, a method is disclosed for organizing and labeling a recycle identification (ID) tag connected by an attachment mechanism to an aperture in a flat body at a first end, and connected to a recycle bag at a second end. According to the method, a first identifying inscription of an association to a specific user is provided on a space for inscribing an identification inscription on a first side of the ID tag. An image is provided on a second side of the ID tag. The first identifying inscription may be at least one of a chronological numbering or alphabetizing adapted to identify to the user of the quantity of recycle bags in his possession.

These and other objects, features, and/or advantages may accrue from various aspects of embodiments of the present invention, as described in more detail below.

### BRIEF DESCRIPTION OF THE DRAWINGS

Various exemplary embodiments of the subject disclosure will be described in detail, wherein like reference numerals refer to identical or similar components or steps, with reference to the following figures, wherein:

FIG. 1 illustrates a front first side view of an exemplary recycle bag ID tag, constructed in accordance with aspects of the subject disclosure.

FIG. 2 illustrates a side view of the exemplary recycle bag ID tag, constructed in accordance with aspects of the subject disclosure.

FIG. 3 illustrates a rear second side view of the exemplary recycle bag ID tag, constructed in accordance with aspects of the subject disclosure.

FIGS. 4-9 illustrate various exemplary configurations and slogans of the exemplary recycle bag ID tag in accordance with aspects of the subject disclosure.

FIG. 10 demonstrates a method for organizing and identifying a variety of recycle bags having various recycle bag ID tags attached thereto in accordance with aspects of the subject disclosure.

FIG. 11 depicts a management system for a retail establishment adapted to send and receive data information between a communication element in the recycle bag ID tag and a central processor in the management system in accordance with aspects of the subject disclosure.

FIG. 12 is an exemplary construction for the recycle bag ID tag, constructed in accordance with aspects of the subject disclosure.

FIG. 13 is an exemplary method for the interaction between the management system in the retail establishment and the recycle bag ID tag, in accordance with aspects of the subject disclosure.

### DETAILED DESCRIPTION OF EXEMPLARY EMBODIMENTS

Particular embodiments of the present invention will now be described in greater detail with reference to the figures.

In accordance with this invention, it is to be understood that the preserver described herein may be adapted for use with various different types of protective coverings, and that the various embodiments described and shown herein are not intended to cover all modifications and changes within the scope and spirit of the invention.

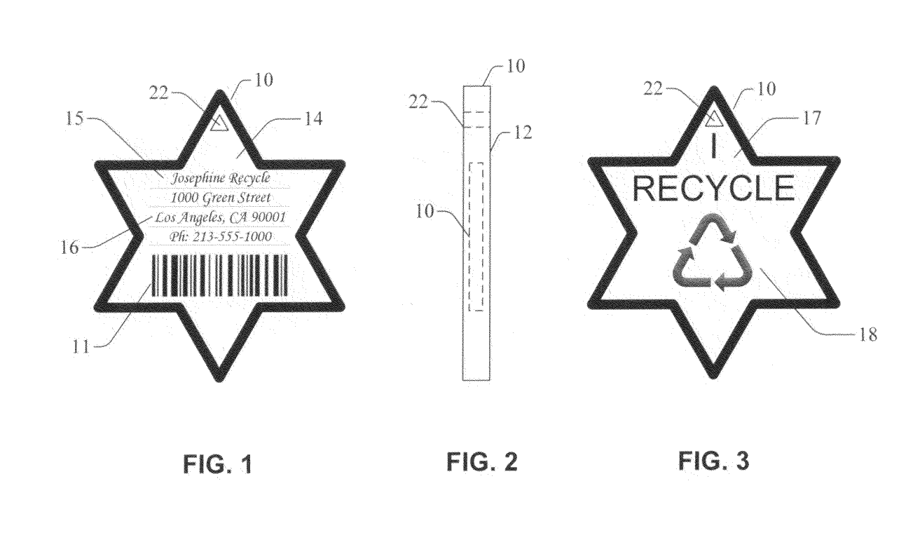

As illustrated in FIGS. 1-3, the subject disclosure is a recycle bag identification (ID) tag 10 for expressing pride in recycling while also serving a practical purpose. The recycle bag ID tag 10 may be a specially designed, decorative identification tag created expressly for recyclable paper and reusable canvas shopping bags. In this manner, users are able to easily accommodate eco-friendly laws being adopted in various cities across the country.

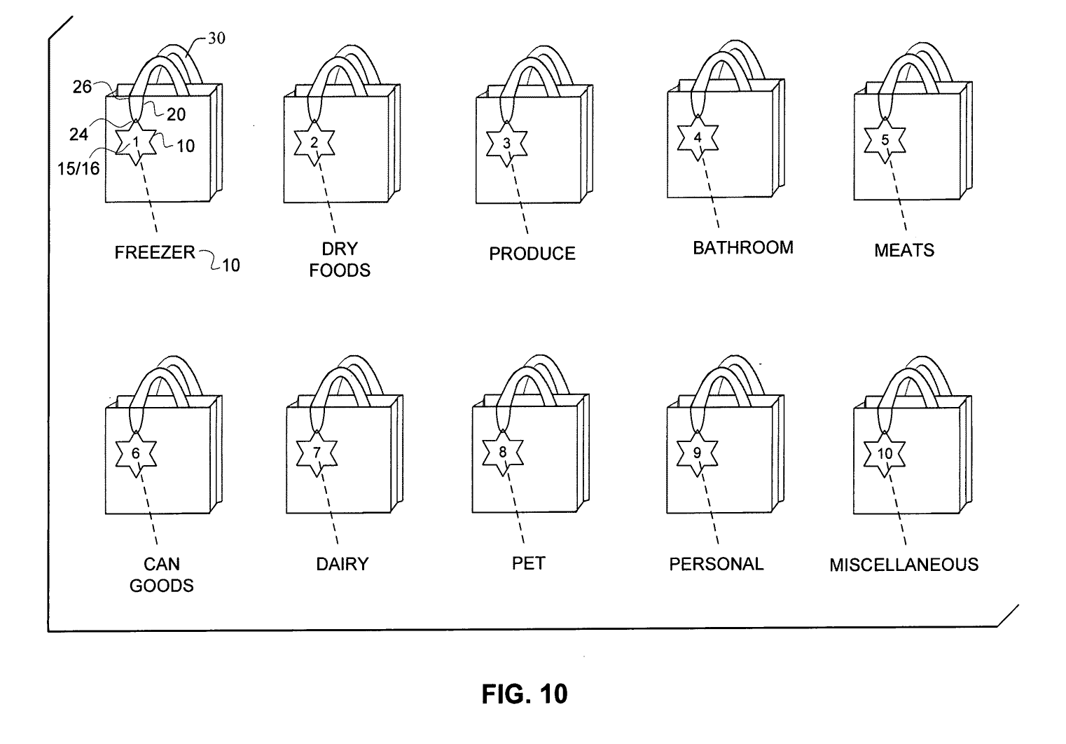

In more detail, FIGS. 1-3 illustrate a recycle bag identification (ID) tag 10 for a recycle bag 30 (as shown in FIG. 10). In one exemplary embodiment, the recycle bag ID tag 10 includes a substantially flat body 12constructed in a preferred shape. Although shown as a star shape in FIGS. 1-3, it is understood that he shape of the recycle bag ID tag 10 may take any shape. The flat body 12 further includes a first side 14 having a space 15 for inscribing an identification inscription 16. The identification inscription 16 may be an impression written on by a user or preprinted. In the alternative, and as described in more detail later, the identification and other pertinent data may be associated with a barcode 11 labeled on the recycle bag ID tag 10. As shown in FIG. 3, the recycle bag ID tag 10 has a second side 17 having sufficient space to include an image 18.

The recycle bag ID tag 10 includes an aperture 21 through which and attachment mechanism 20 (as shown in FIG. 10) may be connected. The exemplary attachment mechanism 20 shown in FIGS. 1 and 10 illustrates the attachment mechanism 20 being connected to an aperture 22 in the flat body 12 of the recycle bag ID tag 10. The attachment mechanism 20 is looped and has a first end 24 connected to recycle bag ID tag 10. A second end 26 of the attachment mechanism 20 is connected to the recycle bag 30.

The shape and material composition of the recycle bag ID tag 10, the symbol and/or other indicia selected for the recycle bag ID tag 10 may be constructed from a variety of durable materials, including, but not limited to: plastic, paper, rubber, metal, fabric, and/or any other suitable composition for constructing the recycle bag ID tag 10.

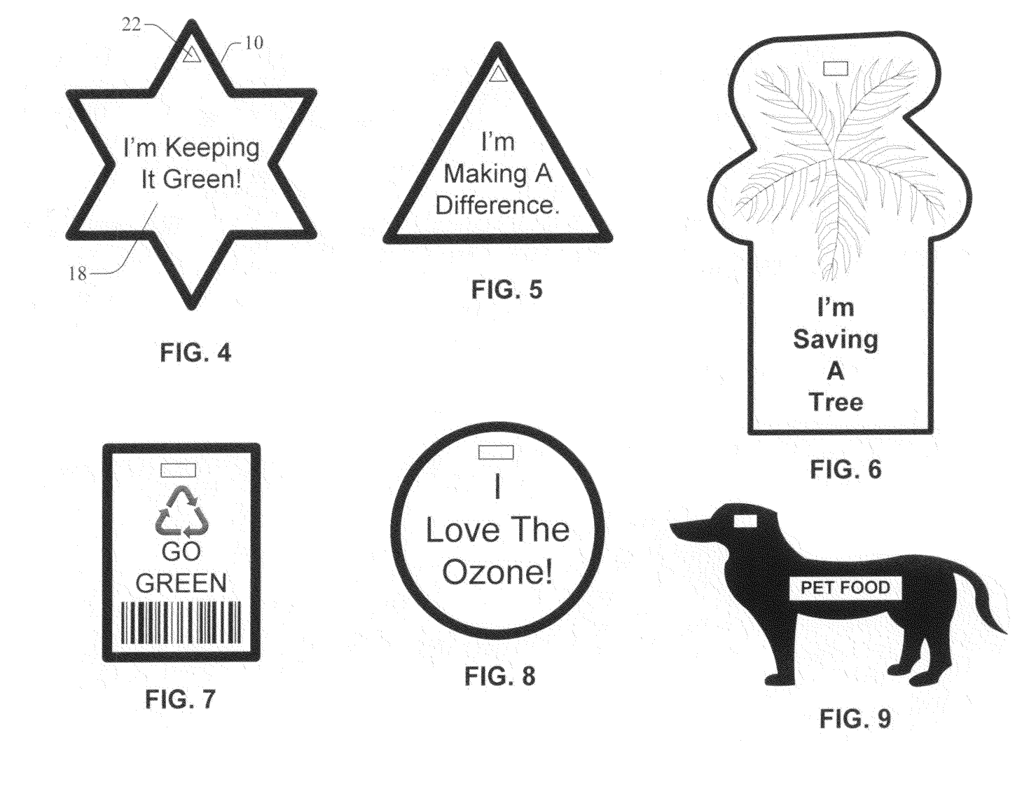

FIGS. 4-9 illustrate that the recycle bag ID tag 10 may take an unlimited number of shapes, sizes, slogans and/or images printed thereon. For example, images being targeted at environmentally recycling slogans, a chronological character (as will be described with respect to FIG. 10) and/or any other image in accordance with this subject disclosure and will be described in more detail below.

Either side, the first side 14 or second side 17 of the recycle bag ID tag 10 may be provided with a variety of different indicia, for example, a trademark, a service mark, a name, an emblem, a logo, a banner, an advertisement and/or any other type of indicia. The user can place indicia to support their favorite business, university, school, local establishment, military, hobbies, and the like.

The recycle bag ID tag 10 may be constructed in a variety of different shapes and sizes, such as but not limited to, circles, rectangles, squares, triangles, trademark designs, logo, brand and mascot outlines, and/or any obtuse shape, design or in accordance with this invention. Although, the size and shape may vary, one preferred dimension for the recycle bag ID may measure approximately 2½″ in height and 2½″ in width at the base. The recycle bag ID tag 10 may also include a variety of different thicknesses.

FIG. 10 illustrates various depictions of at least one example for organizing and identifying various recycle bag ID tags 10 by providing distinguishing indicia on the recycle bag ID tag 10 that will assist with the arrangement and organization of the various recycle bags 30. That is, a method for organizing and labeling a recycle bag ID tag 10 is shown.

Various recycle bag ID tags 10 are shown connected by the attachment mechanisms 20 to various recycle bags 30. According to this method, a first identifying inscription (such as, various bags numbered 1, 2, 3 . . . etc) associated with a specific user is provided on a space 15 for inscribing an identification inscription 16 on the first side 14 of the recycle bag ID tag 10. As described and shown above in FIGS. 1 and 2-9, an image 18 may be provided on a second side 17 of the recycle bag ID tag 10.

The first identifying inscription 15 provided on the recycle bag ID tag 10 is at least one of a chronological character. For example, the chronological characters employed in this example are a plurality of numerals 1 through 10. Alternatively, the chronological character may be, for example, a plurality of alphabet characters A though Z, and/or other indicia such as initials of the user and the like. The objective of providing the identifiable chronological characters is to assist the user in identifying the quantity of recycle bags 30 in his possession, as well as to serve as an identifier of the user's ownership of those particular recycle bags 30. In this way, the user will not easily forget one of her bags at the establishment 64.

For example, if a consumer brings in five of their own recycling bags 30, the various recycling bags 30 may include numbered 1 through 10 recycle bag ID tags 10 (such as shown in FIG. 10) numbered in numerical order (1-10) so the user can keep track of their recycle bags 30. Likewise, the various recycle bag ID tags 10 may include initials and/or other identifying indicia that may be associated with the user or consumer.

The recycle bag ID tags 10 according to this method may be labeled as an item, a shopping list and/or any other indicia to identify the various contents to be inserted into the various recycle bags 30. Such as, for example, “Fruit/Vegetables,” “Cleaning Supplies,” “Personal Care,” “Cold Storage,” “Dry Foods,” “Liquids,” “Freezer,” “Dry Foods,” “Produce,” “Soap,” “Shower,” “Meats,” “Can Goods,” “Bread,” “Dairy,” “Pet,” “Baby,” “Miscellaneous,” “Personal,” or the like.

The recycle bag ID tag 10 may be provided with additional features or functionality, such as by embedding an aromatic fragrance. The recycle bag ID tag 10 may alternatively function as an air freshener. The recycle bag ID may include various aromatic materials, such as, scented, materials, waxy materials, gels, and/or a variety of other synthetic fragrance components now known or later developed in accordance with this invention.

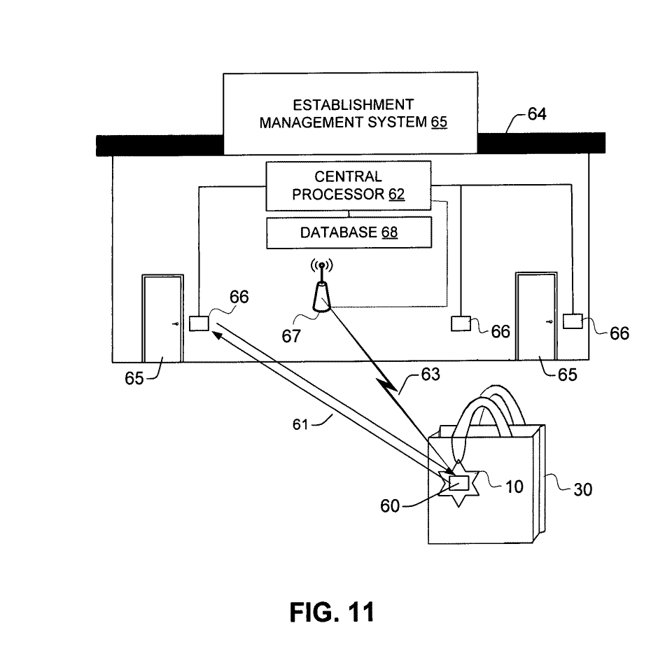

FIG. 11 illustrates a recycle bag ID tag 10 operating with an establishment management system 65 in an establishment 64. The establishment management system 65 includes at least a central processor 62 attached to a database 68 and a plurality of transmit/receivers 66 and alternatively a wireless hotspot transmitter 67 providing coverage encompassing the perimeter of the establishment 64. As shown, the recycle bag ID tag 10 includes a communication element 60 that communicates data information to and from a central processor 62 within the management system 65.

The communication element 60 may be adapted to store and provide various types of data, such as storing identification data, coupon, promotional data, contact information, and the like. The communication element 60 may be embodied as a barcode, an RFID, a Wi-Fi transceiver, an RF transponder, a Near Field Communication device, an 802.XX element (such as one employing Bluetooth® or Zigbee® technology) and/or any other type of, one or two way, communication device now known or later discover in accordance with this subject disclosure. The communication element 60 may transfer data via a physical contact interface, via a near field communication 61, wirelessly 63, and/or any other mechanism for transferring data information.

Where the communication element 60 is employed as a near field communication device, at least one transmit/receiver 66 may be located in a convenient location within the establishment 64 to communicate with the communication element 60 in the recycle bag ID tag 10. The transmit/receiver(s) 66 are connected to the central processor 62. For example, as shown, the transmit/receiver(s) 66 may be positioned near the entry/exit doors 65 so that as the user passes the recycle bag ID tag 10 by the entry/exit doors 65 the communication element 60 and the transmit/receiver 66 can share pertinent data information with each other.

In one example, by locating the transmit/receivers 66 near the entry/exit doors 65, the user and the establishment 64 can track each of the recycle bag ID tags 10 attached to the recycle bags 30 that come through the entry door 65 and leave through the exit door 65. In this way, the user can ensure that she will not lose any of her recycle bags 30 and she will be able to account for all of her recycle bags 30 that she brought into the establishment 64. In the event that one or more of the recycle bags 30 is left in the establishment 64, once the other recycle bags 30 have left through the exit door 65 of the establishment 64, the central processor 62 can determine that the user/shopper has left the establishment 64 and can send an alert to store personnel, or to the user by text or some other form of communication, that they may have left one of their recycle bags 30 behind.

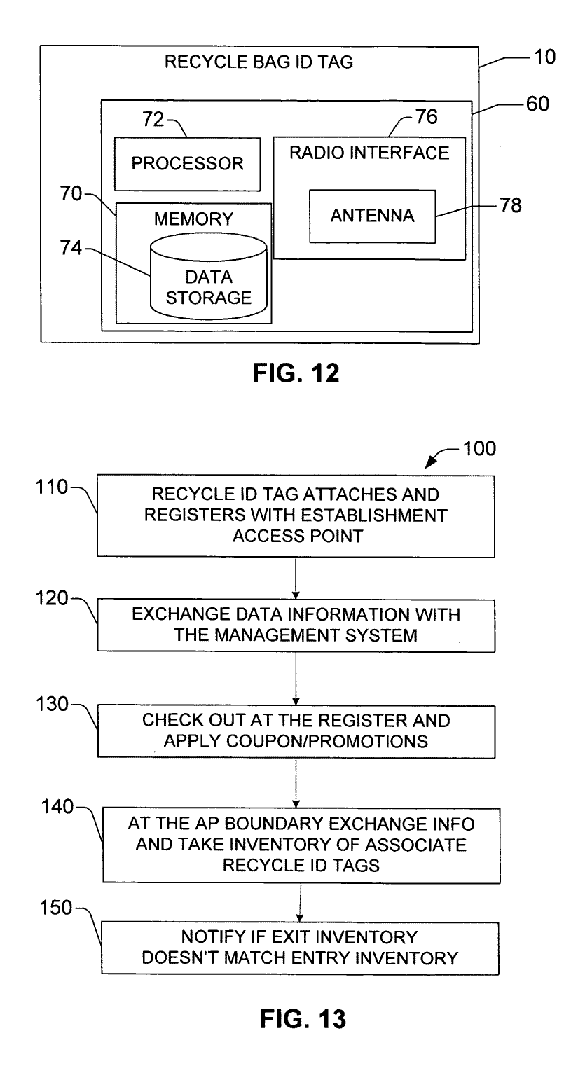

Likewise, various other transmit/receivers 66 may be located throughout the establishment 64 (such as in the isles and/or at the register) and as the communication element 60 comes within range, the transmit/receiver 66 and the communication element 60 can share information with each other. In one example, as the user shops in the establishment 64 and retrieves items from the shelves in the store 64, at least one of the communication elements 60 on the various recycle bag ID tags 10 may record the item placed into the recycle bags 30. In this way, once the user proceeds to the register to check out their items and pay for them, the list of items stored in memory 70 (FIG. 12) on the communication element 60 may be transferred to another transmit/reader 66 element embedded at the register. The list of items stored in the recycle bags 30 may be transferred from the communication element 60 to the transmit/reader 66 at the register for payment processing without the laborious task of having to remove each of the individual item from the recycle bag 30 onto the scanner at the register. One or each of the recycle bag ID tags may include this shopping compilation feature.

FIG. 12 illustrates a schematic of another exemplary communication element 60 embedded within the recycle bag ID tag 10. The communication element 60 may include a processor 72, memory 70 capable of data storage 74 and an antenna within a radio interface 76.

Various types of information may be stored and transmitted by the communication element 60, such as for example, storing and/or rendering coupons, store/club membership savings card information, information obtained from and shared with a database 68 attached to the central processor 62, digital information about the owner, shopping lists, or the like. As mentioned previously, the communication element 60 may be adapted to communicate with a central processor 62 and the centralized database 68 managed by the establishment 64.

Where the communication element 60 is embodied as a barcode 11, the barcode 11 may be scanned at the register or other location in the establishment 64 to transmit information to a bar code reader. Likewise, where the communication element 60 is embedded with near field wireless technology (such as shown in FIG. 12), when the recycle ID tag comes contemporaneously close to a transmit/receiver 66 and/or is sensed by the wireless hotspot transmitter 67, information stored on the communication element 60 can be exchanged with the transmit/receiver 66 (or the wireless hotspot transmitter 67) to redeem promotions, share the identity of the user or other pertinent data information.

The advantage of the establishment 64 managing the central processor 62 and the centralized database 68 is that the establishment 64 can readily gather market demographics about its consumers, as well as granular specific target purchasers. The establishment 64 may use this data information in the future to offer various other advertisements to the consumer via the recycle bag ID tag 10 and/or other mediums, such as email, mass mailing or the like.

The processors 62/72 may be implemented in association with, and/or as part of, the various access technologies used for authenticating and granting access to the communication element 60. The processors 62/72 may be implemented as a programmed general purpose computer, on a special purpose computer, a programmed microprocessor or micro-controller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device processor capable of implementing the therapeutic functions shown in the figures can be used according to this invention. The particular form taken for the processors 62/72 is a design choice and will be obvious and predicable to those skilled in the art.

The processors 62/72 may be associated with a storage unit (not shown) using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like. The processors 62/72 are programmable and can be adapted to provide instruction to the recycle bag ID tag 10.

To facilitate attachment to bags, each recycle bag ID tag 10 may comes complete with an easily affixed, attachment mechanism 30, such as a tie string. The attachment mechanism 30 may be made from a variety of different material, such as a ribbon, rubber, plastic, metal and/or any other material suitable for fastening the recycle bag ID tag 10 to the recycle bag 30.

As described above, the recycle bag ID tag 10 may offer a plethora of colors and designs, the recycle bag ID tags 10 may, for example, feature a selection of various preferred targets slogans on each recycle bag ID tag 10. By way of example, collections of recycle bag ID tag 10 may contain imprinted missives such as, “I'm Saving Trees,” “America Recycles,” “I love to Recycle,” “I'm Going Green,” and “I'm Making a Difference,” just to name a few examples and/or any other preferred inscription. Additionally, the recycle bag ID tag 10 can be made available with various decorative attributes, such as the flags of countries or states, as well as crafty accoutrements that simulate aspects of the natural world, such as a coconut tree with palm fronds. As mentioned above in FIG. 1, to further facilitate identification of a user, the back of each recycle bag ID tag 10 may contain various blank lines for labeling one's name, phone number, e-mail address and/or other contact information about the user.

The recycle bag ID tags 10 can be applied to and removed from a recyclable bag 30 in a matter of seconds. As such, users who implement this creative and thoughtful product are able to take their own bags to shopping centers and display their pride and environmental awareness. Eye-catching, the recycle bag ID tags 10 are sure to capture the attention of passerby, and inspire them to want their own sets. Facilitating responsibility in today's renewed sense of environmentalism, a product such as the recycle bag ID tag 10 will be well received by all who wish to “go green”.

FIG. 13 depicts an exemplary method 100 for organizing, identifying and monitoring various recycle bag ID tags. In a first step 110, when the user enters the establishment, the various recycle bag ID tags attach to an access point, or the establishment management system in an establishment.

In a step 120, the establishment management system exchanges data information with the recycle bag ID tags. As the shopper traverses through the store various information such as coupons, and the like, may be transferred to and from the recycle bag ID tags.

In a step 130, the user has completed their shopping and proceeds to check out their items at the register. At the register, any coupons and/or promotions may be redeemed which are associated with the recycle bag ID tags.

In a step 140, as the user exits the boundary of the establishment, which may be sensed by the transmit/receive or the wireless hotspot transmitter, the establishment management system determines whether each of the recycle bag ID tags which entered the establishment are leaving with the user as he exits the boundary of the establishment.

In step 150, if at least one of the recycle bag ID tags is not accounted for, the establishment management system can send a notification to the user that he may have left one of his bags behind because the exit inventory of recycle bag ID tags doesn't match the entry inventory of recycle bag ID tags. The notification may be transmitted to the user in a variety of different ways, such as by sending a text, calling, emailing, IM and/or any other mode for communicating to the user.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A recycle identification (ID) tag for a recycle bag, comprising:
a substantially flat body constructed in a preferred shape, the flat body further comprising:
a first side having a space for inscribing an identification inscription;
a second side having an image; and
an attachment mechanism, connected to an aperture in the flat body at a first end and connected to the recycle bag at a second end.

2. The recycle ID tag for the recycle bag recited in claim 1, wherein the space for inscribing an identification inscription may be a written or printed impression.

3. The recycle ID tag for the recycle bag recited in claim 1, wherein the recycle ID tag includes an aromatic fragrance.

4. The recycle ID tag for the recycle bag recited in claim 1, wherein the first identifying inscription is at least one of a chronological numbering or alphabetizing adapted to identify to the user of the quantity of recycle bags in his possession.

5. The recycle ID tag for the recycle bag recited in claim 1, wherein the first identifying inscription includes at least one of: contact information about the user, an item or a label from a shopping list.

6. The recycle ID tag for the recycle bag recited in claim 1, wherein the image on a second side of the ID tag includes a radio frequency ID (RFID) tag that is adapted to record and transmit promotional data.

7. The recycle ID tag for the recycle bag recited in claim 1, wherein the second image on a second side of the ID tag includes bar code label that is adapted to record and relay promotional data.

8. The recycle ID tag for the recycle bag recited in claim 1, wherein the recycle ID tag communicates with a central processor within an establishment to send or receive data information.

9. The recycle ID tag for the recycle bag recited in claim 1, wherein the recycle ID tag communicates with a management system in an establishment,
wherein the management system comprises:
a central processor connected to a database containing information pertinent to the recycle ID tag; and
a transmit/receiver located at an entrance or exit of the establishment that communicates data information from the recycle ID tag to and from the central processor.

10. The recycle ID tag for the recycle bag recited in claim 9, wherein the transmit/receiver is a bar code reader that reads a barcode on the recycle ID tag.

11. The recycle ID tag for the recycle bag recited in claim 9, wherein the transmit/receiver is a wireless transceiver capable of sending and receiving data information from a communication element on the recycle ID tag.

12. A method for organizing and labeling a recycle identification (ID) tag connected by an attachment mechanism to an aperture in a flat body at a first end, and connected to a recycle bag at a second end, comprising:
providing a first identifying inscription of an association to a specific user on a space for inscribing an identification inscription on a first side of the ID tag; and
providing an image on a second side of the ID tag.

13. The method recited in claim 12, wherein the providing the first identifying inscription is at least one of a chronological numbering or alphabetizing adapted to identify to the user of the quantity of recycle bags in his possession.

14. The method recited in claim 13, wherein the image on the second side is a label selected from a shopping list is at least one of: Freezer, Dry Foods, Produce, Soap, Shower, Meats, Can Goods, Bread, Dairy, Pet, Baby, Miscellaneous and Personal.

15. The method recited in claim 9, wherein the providing the first identifying inscription includes at least one of: contact information about the user, an item, or a label from a shopping list.

16. The method recited in claim 9, wherein the providing the image on a second side of the ID tag includes a radio frequency ID (RFID) label that is adapted to record and transmit promotional data.

17. The method recited in claim 9, wherein the providing the image on a second side of the ID tag includes bar code label that is adapted to record and relay promotional data.

18. The method recited in claim 9, wherein the recycle ID tag communicates with a management system in an establishment,
wherein the management system comprises:
a central processor connected to a database containing information pertinent to the recycle ID tag; and
a transmit/receiver located at an entrance or exit of the establishment that communicates data information from the recycle ID tag to and from the central processor.

19. The method recited in claim 18, wherein the transmit/receiver is a bar code reader that reads a barcode on the recycle ID tag.

20. The method recited in claim 18, wherein the transmit/receiver is a wireless transceiver capable of sending and receiving data information from a communication element on the recycle ID tag.
